(19) United States
(12) Patent Application Publication
(10) Pub. No.: US 2013/0011749 A1
(43) Pub. Date: Jan. 10, 2013

(54) FUEL CELL

(75) Inventors: Hiroki Mita, Kanagawa (JP); Takaaki Nakagawa, Kanagawa (JP); Yuichi Tokita, Kanagawa (JP); Hideki Sakai, Kanagawa (JP); Ryuhei Matsumoto, Kanagawa (JP)

(73) Assignee: SONY CORPORATION, Tokyo (JP)

(21) Appl. No.: 13/637,701

(22) PCT Filed: Mar. 31, 2011
(86) PCT No.: PCT/JP2011/058745

§ 371 Date: Sep. 27, 2012

(30) Foreign Application Priority Data
Apr. 7, 2010 (JP) 2010-088338

(51) Int. Cl. H01M 8/16

(52) U.S. Cl. 429/401

(57) ABSTRACT

A separator formed of a material, which does not transmit liquid, is provided between a cell unit including an electrode on a surface of which an oxidoreductase is present and a fuel storage unit provided adjacent to the cell unit. It is configured such that power generation is started by supply of fuel solution stored in the fuel storage unit to the cell unit by removal of at least a part of the separator.

### TECHNICAL FIELD

The present invention relates to a fuel cell in which an oxidoreductase is used. More specifically, this relates to technology for supplying fuel to a cell unit of the fuel cell.

### BACKGROUND ART

A bio-fuel cell (hereinafter, also referred to as an enzyme cell) in which the oxidoreductase is immobilized on at least one of a negative electrode and a positive electrode as a catalyst may efficiently extract an electron from the fuel, which cannot be used with a normal industrial catalyst such as glucose and ethanol, for example, so that this attracts attention as a high-capacity and safer next-generation fuel cell.

FIG. 5A is a view illustrating a reaction scheme of the negative electrode of the enzyme cell. FIG. 5B is a view illustrating the reaction scheme of the positive electrode of the enzyme cell. As illustrated in FIGS. 5A and 5B, in a glucose-fueled enzyme cell, oxidation reaction of the glucose progresses at the negative electrode and reduction reaction of oxygen (O₂) in the atmosphere progresses at the positive electrode. At the negative electrode, the electron is transferred in an order of the glucose, glucose dehydrogenase, nicotinamide adenine dinucleotide (NAD⁺), diaphorase, an electron mediator, and the electrode (carbon).

In such bio-fuel cell, power generation is started by supply of the fuel to the cell in general, and the one, which generates power by connecting a fuel cartridge filled with fuel solution to a fuel supply port, is suggested, for example (refer to Patent Document 1, for example). Also, a power supply device in which a beverage container is used as a fuel storage unit and beverage, which becomes the fuel, may be directly supplied from the container to the cell unit is conventionally suggested (refer to Patent Document 2, for example).

### CITATION LIST

### Patent Documents

Patent Document 1: Japanese Patent Application Laid-Open No. 2002-270210
Patent Document 2: Japanese Patent Application Laid-Open No. 2009-140646

### SUMMARY OF THE INVENTION

### Problems to be Solved by the Invention

However, the above-described conventional technology has a following problem. That is to say, the conventional bio-fuel cell has a problem that the fuel solution might be spilled from an inlet at the time of fuel supply. In this case, the spilled fuel solution might be adhered to hand and the like to get the same dirty.

Although this problem may be solved by storage of the fuel in the cell in advance; however, in this case, an enzyme, which acts as the catalyst at the time of reaction, has low tolerance for water, so that there is a new problem that activity thereof is gradually reduced while this is in contact with the fuel solution and sufficient power cannot be obtained at the time of usage.

Therefore, a principal object of the present invention is to provide the bio-fuel cell, which does not require injection operation of the fuel solution and may inhibit reduction in activity of the oxidoreductase.

### Solutions to Problems

A fuel cell according to the present invention includes: a cell unit including an electrode on a surface of which an oxidoreductase is present; a fuel storage unit provided adjacent to the cell unit and in which fuel solution to be supplied to the cell unit is stored; and a separator, which isolates the cell unit and the fuel storage unit from each other, wherein the fuel solution is supplied to the cell unit by removal of at least a part of the separator.

Herein, the surface of the electrode includes all of an outer surface of the electrode and an inner surface of a gap in the electrode and the same applies to a following description.

In the present invention, since the fuel storage unit and the cell unit are isolated from each other by the separator, the activity of the enzyme present on the electrode is not reduced even when the fuel storage unit is filled with the fuel solution in advance. Also, since the fuel solution in the fuel storage unit is supplied to the cell unit and the power generation becomes possible by the removal of a part of the separator, operation to externally inject the fuel solution is not necessary.

The fuel cell may further include another separator arranged adjacent to an air electrode, and oxygen is supplied to the air electrode by removal of at least a part of the another separator.

The separator may be drawable, and further may be insertable/removable.

At least a part of the separator may be broken by bending of a cell main body and the fuel solution may be supplied to the cell unit.

### Effects of the Invention

According to the present invention, since the fuel storage unit in which the fuel solution is stored is provided in the cell, the operation to inject the fuel solution when the power generation is started is not necessary, and since the fuel storage unit and the cell unit are isolated from each other by the separator, it is possible to inhibit the reduction in activity of the oxidoreductase present on the electrode by the fuel solution filled in the fuel storage unit.

### BRIEF DESCRIPTION OF DRAWINGS

FIGS. 1A to 1C are views schematically illustrating a method of supplying fuel in a bio-fuel cell according to a first embodiment of the present invention.

FIG. 2 is a graph illustrating a condition at the time of power generation in each state of the bio-fuel cell illustrated in FIGS. 1A to 1C in which time and a power generation amount are plotted along the abscissa and the ordinate, respectively.

FIGS. 3A to 3C are views schematically illustrating a method of supplying oxygen in a bio-fuel cell according to a modified example of the first embodiment of the present invention.

FIGS. 4A to 4C are views schematically illustrating a method of supplying fuel in a bio-fuel cell according to a second embodiment of the present invention.

FIG. 5A is a view illustrating a reaction scheme of a negative electrode of an enzyme cell. FIG. 5B is a view illustrating the reaction scheme of a positive electrode of the enzyme cell.

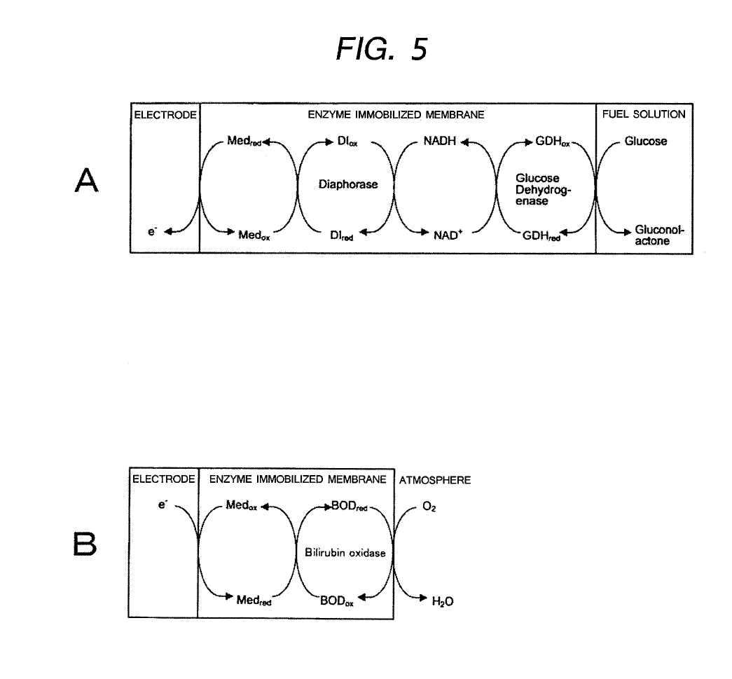

### MODE FOR CARRYING OUT THE INVENTION

Hereinafter, a mode for carrying out the present invention is described in detail with reference to the attached drawings.

Meanwhile, the present invention is not limited to embodiments to be described hereinafter. Also, it is described in a following order.

1. First Embodiment

(Example of bio-fuel cell of which separator is drawable)

2. Modified Example of First Embodiment

(Example of bio-fuel cell provided with another separator on air electrode side)

3. Second Embodiment

(Example of bio-fuel cell of which separator is broken by being bent)

### 1. First Embodiment

### [Entire Structure]

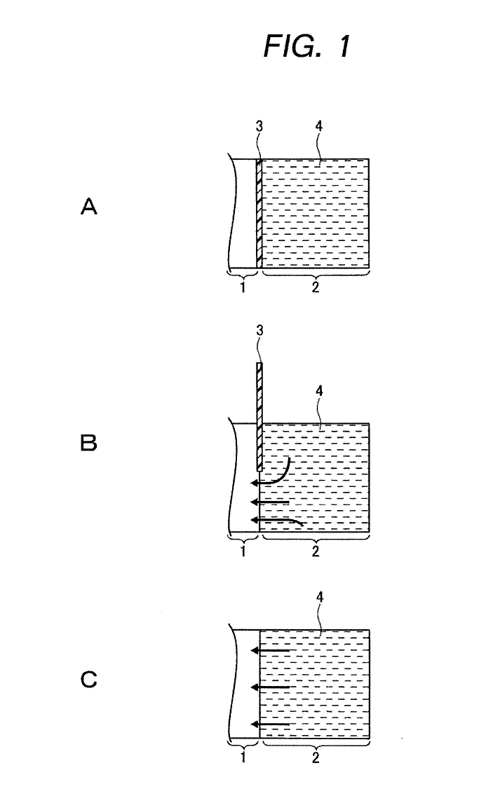

First, a bio-fuel cell according to a first embodiment of the present invention is described. FIGS. 1A to 1C are views schematically illustrating a method of supplying fuel in the bio-fuel cell of this embodiment. In the bio-fuel cell of this embodiment, a cell unit 1 including an electrode on a surface of which an oxidoreductase is present and a fuel storage unit 2 in which fuel solution 4 to be supplied to the cell unit 1 is stored are provided adjacent to each other. A separator 3 is provided therebetween at least in a state before power generation.

### [Cell Unit 1]

The cell unit 1 may be configured such that an anode and a cathode are arranged so as to be opposed to each other across a proton conductor, for example. In this case, the electrode formed of a conductive porous material on a surface of which the oxidoreductase is immobilized and the like may be used as the anode and the electrode formed of the conductive porous material on the surface of which the oxidoreductase and an electron mediator are immobilized and the like may be used as the cathode. Herein, the surface of the electrode includes all of an outer surface of the electrode and an inner surface of a gap in the electrode and the same applies to a following description.

In this configuration, at the anode, an electron is extracted and a proton (H⁺) is generated by degradation of the fuel by the enzyme immobilized on the surface. On the other hand, at the cathode, water is generated by the proton transferred from the anode through the proton conductor, the electron transferred from the anode through an external circuit, and oxygen in the air, for example.

A well-known material may be used as the conductive porous material, which forms the anode, and especially, a carbon-based material such as porous carbon, carbon pellet, carbon felt, carbon paper, and a carbon fiber or carbon particle laminate is preferably used. Further, when the fuel is glucose, for example, glucose dehydrogenase (GDH), which degrades the glucose, may be used as the enzyme immobilized on the surface of the anode.

Further, when a monosaccharide such as the glucose is used as the fuel, it is desirable that a coenzyme oxidase and the electron mediator are immobilized together with an oxidase, which promotes oxidation of the monosaccharide to degrade, such as the GDH on the surface of the anode. The coenzyme oxidase oxidizes a coenzyme reduced by the oxidase (such as NAD⁺ and NADP⁺, for example) and a reductant of the coenzyme (such as NADH and NADPH, for example), and there is diaphorase and the like, for example. By action of the coenzyme oxidase, the electron is generated when the coenzyme is returned to an oxidant and the electron is transferred from the coenzyme oxidase to the electrode through the electron mediator.

A compound having a quinone skeleton is preferably used as the electron mediator and a compound having a naphthoquinone skeleton is especially preferable. Specifically, 2-amino-1,4-naphthoquinone (ANQ), 2-amino-3-methyl-1,4-naphthoquinone (AMNQ), 2-methyl-1,4-naphthoquinone (VK3), 2-amino-3-carboxy-1,4-naphthoquinone (ACNQ) and the like may be used. Anthraquinone and a derivative thereof may also be used, for example, as the compound having the quinone skeleton in addition to the compound having the naphthoquinone skeleton. Further, one or two or more types of other compounds, which act as the electron mediator, may be immobilized together with the compound having the quinine skeleton as needed.

When a polysaccharide is used as the fuel, it is desirable that a degrading enzyme, which promotes degradation such as hydrolysis of the polysaccharide to generate the monosaccharide such as the glucose, is immobilized in addition to the above-described oxidase, coenzyme oxidase, coenzyme, and electron mediator. Meanwhile, the term “polysaccharide” herein means the polysaccharide in a broad sense and is intended to mean all carbohydrates, which generate two or more monosaccharide molecules by the hydrolysis, and includes an oligosaccharide such as a disaccharide, a trisaccharide, and a tetrasaccharide. Specifically, starch, amylose, amylopectin, glycogen, cellulose, maltose, sucrose, lactose and the like are included. They are obtained by binding of two or more monosaccharides and the glucose is included in each polysaccharide as the monosaccharide as a binding unit.

The amylose and the amylopectin are components included in the starch and the starch is a mixture of the amylose and the amylopectin. For example, when glucoamylase is used as the degrading enzyme of the polysaccharide and the glucose dehydrogenase is used as the oxidase to degrade the monosaccharide, the polysaccharide, which may be degraded to the glucose by the glucoamylase, may be used as the fuel. Such polysaccharides include the starch, the amylose, the amylopectin, the glycogen, the maltose and the like, for example. Herein, the glucoamylase is the degrading enzyme, which generates the glucose by the hydrolysis of α-glucan such as the starch, and the glucose dehydrogenase is the oxidase, which oxidizes β-D-glucose to D-glucono-δ-lactone.

On the other hand, a well-known material may be used also as the conductive porous material, which forms the cathode, and especially, the carbon-based material such as the porous carbon, the carbon pellet, the carbon felt, the carbon paper, and the carbon fiber or carbon particle laminate are preferably used. As an oxygen reductase immobilized on the cathode, there are bilirubin oxidase, laccase, ascorbic acid oxidase and the like, for example. Also, as the electron mediator immobilized together with the enzymes, there are potassium hexacyanoferrate, potassium ferricyanide, potassium octacyanotungstate and the like, for example.

Further, any material, which is not electronically conductive and is capable of transferring the proton (H⁺), may be used for the proton conductor and cellophane, gelatin, an ion-exchange resin including a fluorine-containing carbon sulfonic acid group and the like may be used, for example. It is also possible to use an electrolyte as the proton conductor.

Meanwhile, each electrode provided on the cell unit 1 is not limited to that on the surface of which the oxidoreductase is immobilized, and the electrode on the surface of which the oxidoreductase is present may also be used. Specifically, it is also possible to use the electrode on the surface of which a microorganism having the oxidoreductase is adhered and in which the above-described action is performed at the anode and the cathode.

### [Fuel Storage Unit 2]

The fuel storage unit 2 stores the fuel solution 4 and may be formed of a high-density plastic material, which does not transmit gas and liquid, such as a silicon resin and polytetrafluoroethylene (PTFE), for example.

### [Separator 3]

The separator 3 prevents the fuel solution 4 stored in the fuel storage unit 2 from entering the cell unit 1 and is formed of a material, which does not transmit liquid and prevents corrosion by the fuel solution 4. Specifically, the high-density plastic material, which does not transmit gas and liquid, such as the silicon resin and the PTFE, may be used. It is desirable to apply antimicrobial treatment to the separator 3 and this may prevent deterioration of the fuel solution 4 and the like.

The separator 3 is arranged adjacent to the anode, which is a fuel electrode, for example, and a part of or all of the same is drawable as illustrated in FIGS. 1B and 1C. According to this, since the fuel solution 4 is not supplied to the cell unit 1 while this is isolated from the fuel storage unit 2 by the separator 3, it is possible to inhibit reduction in activity of the oxidoreductase present on the electrode. Also, since the separator 3 may be easily removed, the fuel solution 4 may be supplied to the cell unit 1 by simple operation when the power generation is started.

Further, it is more preferable that the separator 3 is insertable/removable such that this may be returned to its original position after this is drawn. According to this, it becomes possible to optionally block the fuel solution 4, so that a fuel supply amount may be adjusted as needed and it is possible to inhibit the reduction in activity of the oxidoreductase until the time of reuse (power generation).

Meanwhile, the separator 3 may be configured such that the fuel solution 4 is supplied to the cell unit 1 by removal of at least a part of the same, and may also be configured to be easily perforated or broken, for example, in addition to being configured to be drawable or insertable/removable as described above.

### [Fuel Solution 4]

The fuel solution 4 is solution including fuel components such as a saccharide, an alcohol, an aldehyde, a lipid, and a protein or at least one of the fuel components. The fuel components used in the bio-fuel cell of this embodiment include saccharides such as the glucose, fructose, and sorbose, alcohols such as methanol, ethanol, propanol, glycerin, and polyvinyl alcohol, aldehydes such as formaldehyde and acetaldehyde, and organic acids such as acetic acid, formic acid, and pyruvic acid, for example. It is also possible to use fat, the protein, and the organic acid, which is an intermediate of metabolism thereof, as the fuel components.

### [Operation]

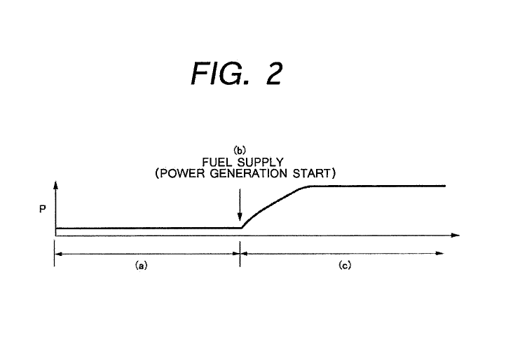

Next, operation of the bio-fuel cell of this embodiment is described. FIG. 2 is a graph illustrating a condition at the time of the power generation in each state of the bio-fuel cell illustrated in FIGS. 1A to 1C in which time and a power generation amount are plotted along the abscissa and the ordinate, respectively. In the bio-fuel cell of this embodiment, the fuel solution 4 is not supplied to the cell unit 1 in a state in which the cell unit 1 and the fuel storage unit 2 are isolated from each other by the separator 3 illustrated in FIG. 1A, so that power is not generated (section (a) illustrated in FIG. 2).

Thereafter, as illustrated in FIG. 1B, when the separator 3 is drawn, the fuel solution 4 is supplied to the cell unit 1 through a portion from which the separator 3 is removed and the power generation is started (time point (b) illustrated in FIG. 2). Then, in a state in which the separator 3 is removed illustrated in FIG. 1C, the fuel solution 4 is supplied from the fuel storage unit 2 to the cell unit 1 and stable power may be obtained (section (c) illustrated in FIG. 2).

In this manner, since the separator 3 is provided between the cell unit 1 and the fuel storage unit 2 in the bio-fuel cell of this embodiment, it is possible to prevent supply of the fuel solution 4 to the cell unit 1 during storage and to supply the fuel solution 4 to the cell unit 1 just before usage. According to this, it is possible to keep the electrode dry even when the cell (fuel storage unit 2) is filled with the fuel solution 4 in advance, so that the enzyme is unlikely to be damaged and decrease in power generation performance due to deactivation may be prevented.

As a result, operation to externally inject the fuel solution at the time of usage becomes unnecessary, so that a problem of spill and adhesion to skin and clothes at the time of fuel injection may be solved. Since it is not required to provide a fuel inlet on a cell main body and a sealed cell may be realized, there is no danger of leak. Further, the bio-fuel cell of this embodiment is configured such that the fuel solution 4 in the fuel storage unit 2 is supplied to the cell unit 1 and the power generation is started by simple operation to remove the separator 3, so that troublesome operation is not required and this is preferable for toys used by children.

Meanwhile, the configuration of this embodiment may be applied to both of a “soak type” in which both of the anode and cathode of the cell unit 1 are brought into contact with the fuel solution and an “atmospheric exposure type” in which only the anode is brought into contact with the fuel solution. The configuration of this embodiment may be applied not only to a “unique cell” structure in which one cell unit is provided on the cell main body but also to a structure in which a plurality of cell units are connected in series or in parallel. In this case, it may be configured such that the separator is provided for each cell unit and a plurality of separators are simultaneously removed.

### 2. Modified Example of First Embodiment

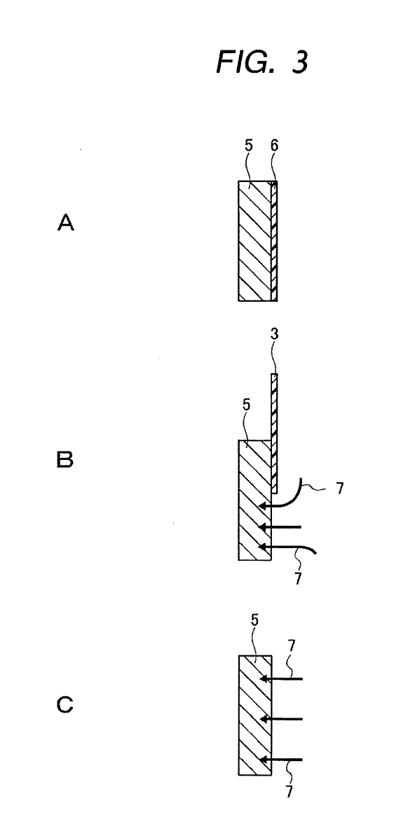

Next, a bio-fuel cell according to a modified example of the first embodiment is described. FIGS. 3A to 3C are views schematically illustrating a method of supplying oxygen in the bio-fuel cell of this modified example. In the bio-fuel cell of this modified example, a cell unit 1 is an “atmospheric exposure type” and a separator 6 is arranged adjacent to an air electrode (cathode) 5 as illustrated in FIG. 3A in addition to a separator 3, which isolates the cell unit 1 and a fuel storage unit 2 from each other illustrated in FIG. 1.

### [Separator 6]

The separator 6 prevents contact of the air electrode 5 with air (oxygen) and is formed of a material, which does not transmit gas, especially oxygen 7. Specifically, the separator 6 may be formed of a high-density plastic material and the like, which does not transmit gas and liquid, such as a silicon resin and PTFE. The separator 6 may be configured such that the oxygen 7 is supplied to the air electrode 5 by removal of at least a part of the same and a drawable configuration, an insertable/removable configuration and the like may be adopted as the above-described separator 3, which isolates the cell unit 1 and the fuel storage unit 2 from each other.

### [Operation]

Next, operation of the bio-fuel cell of this modified example is described. In the bio-fuel cell of this modified example, since the oxygen 7 is not supplied to the air electrode 5 in a state in which the air electrode 5 is covered with the separator 6 illustrated in FIG. 3A, power is not generated (corresponding to section (a) illustrated in FIG. 2). On the other hand, when the power is generated, the separator 3, which isolates the cell unit 1 and the fuel storage unit 2 from each other, is removed and the separator 6, which covers the air electrode 5, is also removed as illustrated in FIG. 3B. According to this, the fuel solution 4 is supplied to a fuel electrode and the oxygen 7 is supplied to the air electrode 5 through a portion from which the separator 6 is removed, then power generation is started (corresponding to time point (b) illustrated in FIG. 2). Then, in a state in which the separator 6 is removed illustrated in FIG. 3C, the oxygen 7 is supplied to the air electrode 5 and stable power may be obtained (section (c) illustrated in FIG. 2).

In this manner, in the bio-fuel cell of this modified example, the separator is arranged also on the air electrode, so that it is possible to block moisture from the atmosphere, thereby inhibiting reduction in activity of oxygen on the air electrode in addition to that on the fuel electrode. Meanwhile, the configuration and the effect other than the above-described ones in this modified example are similar to those of the above-described first embodiment.

### 3. Second Embodiment

### [Entire Structure]

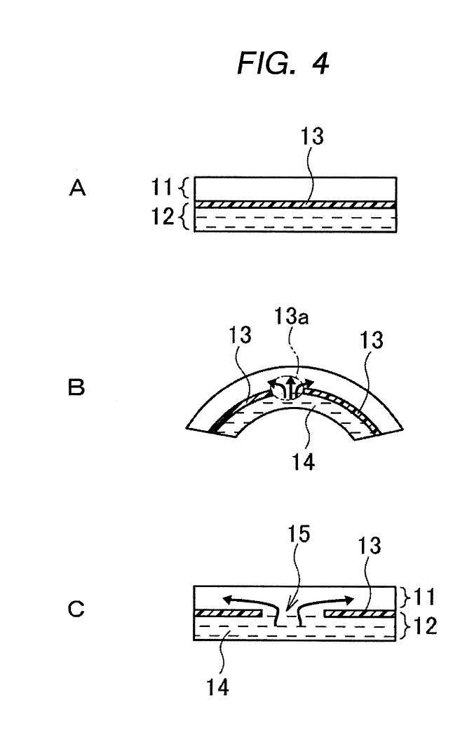

Next, a bio-fuel cell according to a second embodiment of the present invention is described. FIGS. 4A to 4C are views schematically illustrating a method of supplying fuel in the bio-fuel cell of this embodiment. In the bio-fuel cell of this embodiment, components such as an electrode, a power collector, a casing and the like are formed of a flexible material, so that all of or a part of the cell may be bent. If the electrode and the power collector are formed of fibrous carbon and the casing, which covers the cell unit, is formed of a plastic sheet, for example, all of or a part of the cell may be bent in this manner.

Also, as illustrated in FIG. 4A, the bio-fuel cell of this embodiment also is provided with a cell unit 11 including an electrode on a surface of which an oxidoreductase is present and a fuel storage unit 12 in which fuel solution 14 to be supplied to the cell unit 11 is stored adjacent to each other as in the above-described first embodiment. At least in a state before power generation, a separator 13, which isolates the cell unit 11 and the fuel storage unit 12 from each other, is provided therebetween.

### [Separator 13]

The separator 13 is formed of a material, which does not transmit liquid and prevents corrosion by the fuel solution 14, and further, when this is bent, a part of or all of the same is broken as illustrated in FIG. 4B and the fuel solution 14 is supplied to the cell unit 1 through a broken portion 13a. Such separator 13 may be realized by thin-film glass, a plastic substrate on which a notch is formed in advance and the like, for example.

### [Operation]

Next, operation of the bio-fuel cell of this embodiment is described. In the bio-fuel cell of this embodiment, the fuel solution 14 is not supplied to the cell unit 11 in a state in which the cell unit 11 and the fuel storage unit 12 are isolated from each other by the separator 13 illustrated in FIG. 4A, so that power is not generated (section (a) illustrated in FIG. 2).

When a cell main body is bent and a part of or all of the separator 13 is broken as illustrated in FIG. 4B, the fuel solution 4 flows to the cell unit 1 through the broken portion 13a and the power generation is started (time point (b) illustrated in FIG. 2). Thereafter, as illustrated in FIG. 4C, even when a bent state is released, the fuel solution 4 is supplied from the fuel storage unit 2 to the cell unit 1 through a fuel supply hole 15 (broken portion 13a) formed on the separator 13, so that stable power may be obtained (section (c) illustrated in FIG. 2).

In a case of the bio-fuel cell of this embodiment having flexibility, it becomes possible to start generating the power by more simple operation by providing the separator 3, a part of or all of which is broken by being bent to form the fuel supply hole 15, between the cell unit 1 and the fuel storage unit 2.

Meanwhile, the configuration and the effect other than those of this embodiment are similar to those of the above-described first embodiment. Also, it is possible to provide another separator adjacent to an air electrode also in the bio-fuel cell of this embodiment, and in this case, the effect similar to that of the modified example of the first embodiment described above may be obtained.

### REFERENCE SIGNS LIST

1, 11 Cell unit
2, 12 Fuel storage unit
3, 6, 13 Separator
4, 14 Fuel solution
5 Air electrode
7 Oxygen
13a Broken portion
15 Fuel supply hole

1. A fuel cell, comprising:
a cell unit including an electrode on a surface of which an oxidoreductase is present;
a fuel storage unit provided adjacent to the cell unit and in which fuel solution to be supplied to the cell unit is stored; and
a separator, which isolates the cell unit and the fuel storage unit from each other, wherein
the fuel solution is supplied to the cell unit by removal of at least a part of the separator.

2. The fuel cell according to claim 1, further comprising:
another separator arranged adjacent to an air electrode, wherein
oxygen is supplied to the air electrode by removal of at least a part of the another separator.

3. The fuel cell according to claim 1 or 2, wherein
the separator is drawable.

4. The fuel cell according to claim 3, wherein
the separator is insertable/removable.

5. The fuel cell according to claim 1 or 2, wherein
at least a part of the separator is broken by bending of a cell main body and the fuel solution is supplied to the cell unit.
